(19) United States
(12) Patent Application Publication
(10) Pub. No.: US 2025/0244985 A1
(43) Pub. Date: Jul. 31, 2025

(54) STORAGE MEDIUM AND CONTROL METHOD

(71) Applicant: CANON KABUSHIKI KAISHA, Tokyo (JP)

(72) Inventor: HARUNA SATO, Tokyo (JP)

(21) Appl. No.: 19/034,091

(22) Filed: Jan. 22, 2025

(30) Foreign Application Priority Data
Jan. 25, 2024 (JP) 2024-009688

(51) Int. Cl. G06F 8/61; H04N 1/00

(52) U.S. Cl. CPC G06F 8/61; H04N 1/00941

(57) ABSTRACT

A control method includes performing control in such a manner that, even in a case where a communication apparatus incompatible with a predetermined program is included in one or a plurality of communication apparatuses found by a search conducted by a first information processing apparatus, the one or the plurality of communication apparatuses including the communication apparatus incompatible with the predetermined program is displayed on a first screen, and performing control in such a manner that, in a case where a communication apparatus incompatible with the predetermined program is included in one or a plurality of communication apparatuses found by a search conducted by a second information processing apparatus, the one or the plurality of communication apparatuses not including the communication apparatus incompatible with the predetermined program is displayed on a second screen.

### BACKGROUND

### Field of the Disclosure

Aspects of the present disclosure generally relate to a storage medium and a control method.

### Description of the Related Art

Japanese Patent Application Laid-Open No. 2017-219961 discusses a technique for performing cooperative launching of a second program via a first program.

Furthermore, with the popularization of a configuration of performing processing related to a second program via a first program, it has been desired to increase the usability of such a configuration.

### SUMMARY

Aspects of the present disclosure are generally directed to increasing the usability of a configuration of performing processing related to a second program via a first program.

According to an aspect of the present disclosure, a control method for a first information processing apparatus including a predetermined program capable of running on an operating system (OS) and including a first operation environment present on a first OS running as a host OS but not present on a guest OS and a second information processing apparatus including the predetermined program and including a second operation environment present on a second OS running as the host OS and present on the guest OS includes displaying, on a first screen in the first information processing apparatus, one or a plurality of communication apparatuses found by a search conducted based on an instruction issued by the predetermined program running in the first operation environment, receiving, in the first information processing apparatus, selection of any one communication apparatus from among the one or the plurality of communication apparatuses displayed on the first screen, preforming, in a case where the communication apparatus selected from among the one or the plurality of communication apparatuses displayed on the first screen is a communication apparatus incompatible with the predetermined program, processing related to another program different from the predetermined program in the first information processing apparatus, displaying, on a second screen in the second information processing apparatus, one or a plurality of communication apparatuses found by a search conducted based on an instruction issued by the predetermined program running in the second operation environment, receiving, in the second information processing apparatus, selection of any one communication apparatus from among the one or the plurality of communication apparatuses displayed on the second screen, performing control in such a manner that, even in a case where a communication apparatus incompatible with the predetermined program is included in the one or the plurality of communication apparatuses found by the search conducted by the first information processing apparatus, the one or the plurality of communication apparatuses including the communication apparatus incompatible with the predetermined program is displayed on the first screen, and performing control in such a manner that, in a case where a communication apparatus incompatible with the predetermined program is included in the one or the plurality of communication apparatuses found by the search conducted by the second information processing apparatus, the one or the plurality of communication apparatuses not including the communication apparatus incompatible with the predetermined program is displayed on the second screen.

Further features of the present disclosure will become apparent from the following description of exemplary embodiments with reference to the attached drawings.

### BRIEF DESCRIPTION OF THE DRAWINGS

FIG. 1 is a diagram illustrating an example of a configuration of a communication system.

FIG. 2 is a diagram illustrating a wireless connection sequence in a Wi-Fi Direct (WFD) mode.

FIGS. 3A and 3B are diagrams illustrating software configurations of an information processing apparatus.

FIG. 4 is a diagram illustrating a software configuration of a communication application (communication app).

FIG. 5 is a flowchart illustrating an example of a search processing procedure for a printer.

FIG. 6 is a diagram illustrating an example of a registration screen for a printer.

FIG. 7 is a flowchart illustrating an example of a registration processing procedure for a printer.

FIGS. 8A and 8B are diagrams each illustrating an example of a message which is displayed in registration of a printer.

### DESCRIPTION OF THE EMBODIMENTS

Various exemplary embodiments, features, and aspects of the disclosure will be described in detail below with reference to the drawings. Furthermore, the following exemplary embodiments should not be construed to limit the disclosure set forth in claims. While a plurality of features and aspects are described in the exemplary embodiments, not all of the plurality of features and aspects are necessarily essential for the disclosure, and, moreover, the plurality of features and aspects can be optionally combined. Additionally, in the accompanying drawings, the same or similar constituent elements are assigned the respective same reference numerals and any repetitive description thereof may be omitted as appropriate.

Moreover, with regard to the present disclosure, it should be understood that embodiments obtained by appropriately making alternations or improvements to the exemplary embodiments described below based on the ordinary knowledge of one skilled in the art within the range not departing from the gist of the present disclosure also fall within the scope of the present disclosure.

An information processing apparatus and a communication apparatus which are included in a communication system according to an exemplary embodiment of the present disclosure are described. While, in the present exemplary embodiment, a smartphone is described as an example of the information processing apparatus, the present exemplary embodiment is not limited to this, and, for example, various apparatuses, such as a mobile terminal, a notebook personal computer (PC), a tablet terminal, a personal digital assistant (PDA), and a digital camera, can be applied as the information processing apparatus. Moreover, various apparatuses can be applied as the communication apparatus, as long as those are capable of performing wireless communication with the information processing apparatus. For example, if the communication apparatus is a printer, the applicable printer includes, for example, an inkjet printer and an electrophotographic printer. Moreover, not only a printer but also a scanner, a copying machine, a facsimile apparatus, a portable terminal, a smartphone, a notebook PC, a tablet terminal, a PDA, a digital camera, a music playback device, a television set, or a smart speaker can be applied as the communication apparatus. Besides, a multifunction peripheral equipped with a plurality of functions including, for example, a copying function, a facsimile (FAX) function, a printing function, and a scanning function can also be applied as the communication apparatus. In the present exemplary embodiment, the communication apparatus is assumed to be a multifunction printer equipped with, for example, a printing function and a scanning function.

### 21 Hardware Configuration of Each Apparatus>

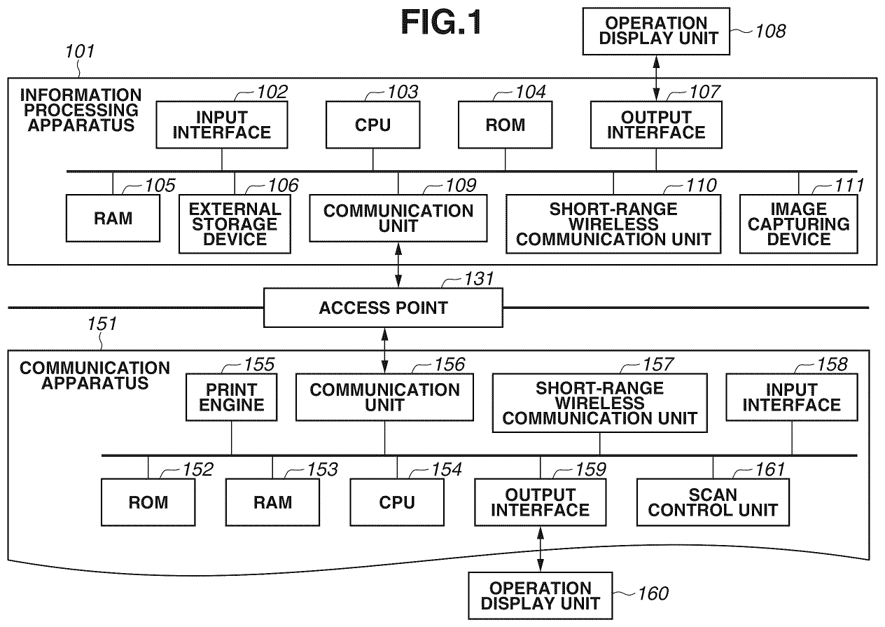

First, configurations of an information processing apparatus and a communication apparatus capable of communicating with the information processing apparatus, which are included in the communication system in the present exemplary embodiment, are described with reference to the block diagram of FIG. 1. Moreover, while, in the present exemplary embodiment, the following configurations are described as an example, the present exemplary embodiment should not be construed to limit functions thereof to those illustrated in FIG. 1.

An information processing apparatus 101 includes, for example, an input interface 102, a central processing unit (CPU) 103, a read-only memory (ROM) 104, a random access memory (RAM) 105, an external storage device 106, an output interface 107, an operation display unit 108, a communication unit 109, a short-range wireless communication unit 110, and an image capturing device 111.

The input interface 102 is an interface for receiving a data input or an operation instruction from the user, and is composed of, for example, a physical keyboard or physical buttons and a touch panel. Furthermore, the output interface 107 described below and the input interface 102 can be integrated into the same configuration, and both outputting of a screen and reception of an operation performed by the user can be performed with the same configuration.

The CPU 103 is a system control unit, and controls the entire information processing apparatus 101.

The ROM 104 stores fixed data such as control programs, data tables, and a built-in operating system (hereinafter referred to as “OS”) program, which the CPU 103 executes. In the present exemplary embodiment, the respective control programs stored in the ROM 104 are used to perform software execution control, such as scheduling, task switching, and interrupt processing, under the control of the built-in OS stored in the ROM 104. Furthermore, in the present exemplary embodiment, an OS which the ROM 104 stores and which runs on the information processing apparatus 101 is assumed to be an Android® OS, which is provided by Google LLC, or a Chrome® OS, which is provided by Google LLC. In a case where the OS running on the information processing apparatus 101 is a Chrome OS, the ROM 104 is assumed to also retain a virtual Android OS for causing an application for Android OS described below to run on the information processing apparatus 101.

The RAM 105 is configured with, for example, a static random access memory (SRAM), which requires a backup power source. Furthermore, the RAM 105 causes data to be retained by a primary battery for data backup (not illustrated) and is, therefore, able to store important data, such as program control variables, without volatilizing such data. Moreover, a memory area for storing, for example, setting information about the information processing apparatus 101 or management data about the information processing apparatus 101 is also provided in the RAM 105. Moreover, the RAM 105 is also used as a main memory and a work memory for the CPU 103.

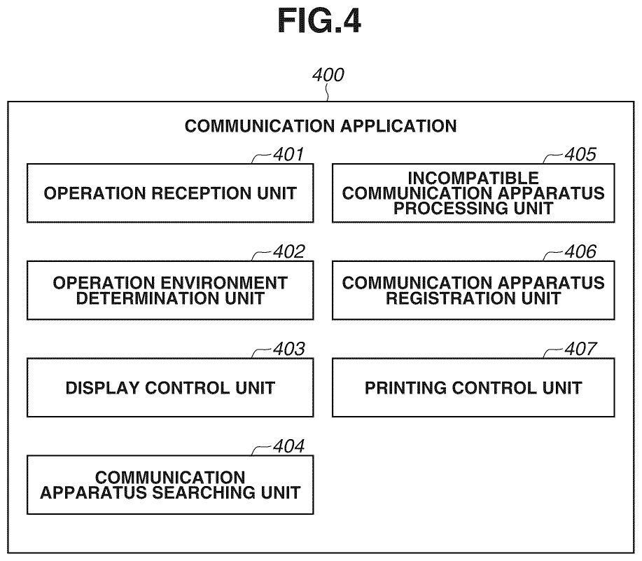

The external storage device 106 includes an application program which has the function of communicating with a communication apparatus 151 (hereinafter referred to as a “communication application 400” or a “communication app 400” (see FIG. 4)). Furthermore, the communication application 400 is, specifically, for example, an application which has a printing function for causing the communication apparatus 151 to perform printing and a scanning function for causing the communication apparatus 151 to perform scanning. However, the communication application 400 is not limited to this configuration, but can be an application which has any one function of the printing function and the scanning function or can be an application which has another function. Moreover, the external storage device 106 stores various programs, such as a printing information generation program for generating printing information which the communication apparatus 151 is able to interpret and an information transmission and reception control program for performing transmission and reception between the information processing apparatus 101 and the communication apparatus 151, to which the information processing apparatus 101 is connecting via the communication unit 109. The external storage device 106 also stores various pieces of information which these programs use. The external storage device 106 also stores image data obtained from another information processing apparatus or the Internet via the communication unit 109. Furthermore, in the present exemplary embodiment, the communication application 400 is assumed to be an application for Android OS.

The output interface 107 is an interface which performs control for the operation display unit 108 to perform displaying of data and perform notification of the state of the information processing apparatus 101.

The operation display unit 108 is configured with, for example, a light-emitting diode (LED) or a liquid crystal display (LCD), and performs displaying of data and notification of the state of the information processing apparatus 101. Furthermore, on the operation display unit 108, a software keyboard including keys such as numeral input keys, mode setting keys, a confirmation key, a cancel key, and a power key can be installed, thus enabling receiving an input from the user via the operation display unit 108.

The communication unit 109 is a configuration which connects to apparatuses, such as the communication apparatus 151, to perform data communication. For example, the communication unit 109 is able to connect to an access point (not illustrated) included in the communication apparatus 151. By the communication unit 109 and the access point included in the communication apparatus 151 connecting to each other, the information processing apparatus 101 and the communication apparatus 151 become able to communicate with each other. In the following description, an access point may be abbreviated to “AP”. Furthermore, the communication unit 109 can be configured to directly communicate with the communication apparatus 151 via wireless communication, and can be configured to communicate with the communication apparatus 151 via an access point 131 present outside the information processing apparatus 101 and outside the communication apparatus 151. In the present exemplary embodiment, the wireless communication method which the communication unit 110 uses is assumed to be a communication standard of the IEEE 802.11 series. Furthermore, the communication standard of the IEEE 802.11 series is Wi-Fi® (Wireless Fidelity).

Moreover, examples of the access point 131 include devices such as a wireless local area network (LAN) router. Furthermore, in the present exemplary embodiment, a method in which the information processing apparatus 101 and the communication apparatus 151 directly connect to each other without via any external access point is referred to as a “direct connection method”. Moreover, a method in which the information processing apparatus 101 and the communication apparatus 151 connect to each other via an external access point 131 is referred to as an “infrastructure connection method”.

The short-range wireless communication unit 110 is a configuration which wirelessly connects to an apparatus such as the communication apparatus 151 at close range to perform data communication, and performs communication by a communication method different from that of the communication unit 109. The short-range wireless communication method which is used by the short-range wireless communication unit 110 is, for example, Bluetooth® or Near Field Communication (NFC). Bluetooth can be Bluetooth Classic or can be Bluetooth Low Energy (BLE). The short-range wireless communication unit 110 is able to connect to, for example, a short-range wireless communication unit 157 included in the communication apparatus 151.

The image capturing device 111 is a device which converts an image captured by an image sensor contained therein into digital data. The obtained digital data is then once stored in the RAM 105. After that, the digital data is converted into data with a predetermined image format by a program which the CPU 103 executes, and is then stored, as image data, in the external storage device 106.

A ROM 152 stores fixed data such as control programs, data tables, and an OS program, which a CPU 154 executes.

The communication apparatus 151 includes, for example, the ROM 152, a RAM 153, the CPU 154, a print engine 155, a communication unit 156, a short-range wireless communication unit 157, an input interface 158, an output interface 159, an operation display unit 160, and a scan control unit 161. In response to a connection mode (communication mode) being set, the communication apparatus 151 is able to operate with the set connection mode.

The communication unit 156 is a configuration which is used for the communication apparatus 151 to perform communication with another apparatus, and, in the present exemplary embodiment, the communication unit 156 is assumed to perform communication by the communication standard of the IEEE 802.11 series. The communication unit 156 includes, as an access point contained in the communication apparatus 151, an access point used to connect to an apparatus such as the information processing apparatus 101. Furthermore, such an access point is able to connect to the communication unit 109 of the information processing apparatus 101. Furthermore, the communication unit 156 can perform direct communication with the information processing apparatus 101 by wireless communication, or can perform communication with the information processing apparatus 101 via the access point 131. Moreover, the communication unit 156 can include hardware functioning as an access point, or can operate as an access point by software for causing the communication unit 156 to function as an access point. Furthermore, in the present exemplary embodiment, the communication unit 156 and the short-range wireless communication unit 157 are assumed to be integrally implemented with a single wireless chip. Thus, in the present exemplary embodiment, a combo chip which is compatible with both a communication function of the communication standard of the IEEE 802.11 series and a communication function corresponding to the short-range wireless communication method is assumed to be used. However, the present exemplary embodiment is not limited to this configuration, and the communication unit 156 and the short-range wireless communication unit 157 can be separately implemented by respective different wireless chips.

The RAM 153 is configured with, for example, a dynamic random access memory (DRAM), which requires a backup power source. Furthermore, the RAM 153 causes data to be retained by electric power being supplied from a power source for data backup (not illustrated) and is, therefore, able to store important data, such as program control variables, without volatilizing such data. Moreover, the RAM 153 is also used as a main memory and a work memory for the CPU 154, and serves as a receive buffer for temporarily storing printing information received from, for example, the information processing apparatus 101 and stores various pieces of information received therefrom.

The ROM 152 stores fixed data such as control programs, data tables, and an OS program, which the CPU 154 executes. In the present exemplary embodiment, the control programs stored in the ROM 152 are used to perform software execution control, such as scheduling, task switching, and interrupt processing, under the control of the built- in OS stored in the ROM 152. Moreover, a memory area for storing data which is required to be retained even in a case where electric power supply is not performed, such as setting information about the communication apparatus 151 or management data about the communication apparatus 151, is also provided in the ROM 152.

The CPU 154 is a system control unit, and controls the entire communication apparatus 151.

The print engine 155 forms an image on a recording medium such as paper by applying a recording agent such as ink to the recording medium based on information stored in the RAM 153 or a print job received from, for example, the information processing apparatus 101, and thus outputs a print result. At this time, since a print job transmitted from, for example, the information processing apparatus 101 is large in the amount of data to be transmitted and requires high-speed communication, the communication apparatus 151 receives the print job via the communication unit 156, which is capable of performing communication at higher speed than the short-range wireless communication unit 157.

The short-range wireless communication unit 157 is a configuration which wirelessly connects to an apparatus such as the information processing apparatus 101 at close range and performs data communication, and performs communication by a communication method different from that of the communication unit 156. The short-range wireless communication method which is used by the short-range wireless communication unit 157 is, for example, Bluetooth® or NFC. Bluetooth can be Bluetooth Classic or can be Bluetooth Low Energy (BLE). The short-range wireless communication unit 157 is able to connect to the short-range wireless communication unit 110.

The input interface 158 is an interface for receiving a data input or an operation instruction from the user, and is composed of, for example, a physical keyboard or physical buttons and a touch panel. Furthermore, the output interface 159 described below and the input interface 158 can be integrated into the same configuration, and outputting of a screen and reception of an operation performed by the user can be performed with same configuration. The output interface 159 is an interface which performs control for the operation display unit 160 to perform displaying of data and perform notification of the state of the communication apparatus 151.

The operation display unit 160 is configured with, for example, a light-emitting diode (LED) or a liquid crystal display (LCD), and performs displaying of data and notification of the state of the communication apparatus 151. Furthermore, on the operation display unit 160, a software keyboard including keys such as numeral input keys, mode setting keys, a confirmation key, a cancel key, and a power key can be installed, thus enabling receiving an input from the user via the operation display unit 160.

The scan control unit 161 includes an image sensor unit (reading unit) which performs scanning of an original placed on a document positioning plate or an automatic document feeder (ADF) (each not illustrated). Furthermore, the image sensor unit includes a light source which irradiates an original with light and an image sensor in which elements for reading reflected light from the original and performing photoelectric conversion of the reflected light are arrayed. The scan control unit 161 analog-digital (A/D) converts an analog electrical signal obtained by the image sensor unit reading an original and thus acquires image data. The scan control unit 161 also includes a circuit which performs direct memory access (DMA) transfer to store the acquired image data in the RAM 153.

### <Direct Connection Method>

Direct connection refers to a configuration in which apparatuses directly (i.e., peer to peer) perform wireless connection with each other without via an external device such as the access point 131. The communication apparatus 151 is able to operate with a mode for performing communication by direct connection (direct connection mode) as one of connection modes. With regard to Wi-Fi communication, the mode for performing communication by direct connection includes a plurality of modes such as a software AP mode and a Wi-Fi Direct® mode. Wi-Fi Direct is hereinafter referred to as “WFD”.

The mode for performing direct connection by WFD is referred to as a “WFD mode”. WFD is a standard formulated by the Wi-Fi Alliance, and is a standard included in the communication standards of the IEEE 802.11 series. In the WFD mode, after equipment serving as a communication partner has been searched for by equipment search information, the roles of a group owner (GO) in peer-to-peer (P2P) communication and a client in P2P communication are determined, and then, the remaining processing operations for wireless connection are performed. The group owner is equivalent to a master station (master device) in Wi-Fi and the client is equivalent to a slave station (slave device) in Wi-Fi.

This role determination corresponds to, for example, GO Negotiation in the case of P2P communication. Furthermore, in the WFD mode in a state before the role determination is performed, the communication apparatus 151 is in the state of serving as neither a master station nor a slave station. Specifically, first, between pieces of equipment which perform communication, equipment on one side issues equipment search information to equipment which performs communication and thus searches for equipment to which the equipment on one side connects with the WFD mode. When equipment on the other side serving as a communication partner has been found, the equipment on one side and the equipment on the other side confirm pieces of information about services and functions which they are able to supply between each other. Furthermore, this equipment supply information confirmation is optional and is not essential. This equipment supply information confirmation phase corresponds to, for example, Provision Discovery in P2P communication. Next, they confirm this equipment supply information with respect to one another, and thus determine, as their roles, which serves as a client in P2P communication and which serves as a group owner in P2P communication. Next, after the client and the group owner are determined, they exchange parameters used for performing communication by WFD between them. Based on the exchanged parameters, the client and the group owner in P2P communication perform the remaining processing operations for wireless connection and for Internet Protocol (IP) connection between them. Furthermore, in the case of the WFD mode, the communication apparatus 151 can, without performing the above-mentioned GO Negotiation, necessarily operate as the GO (group owner). Thus, the communication apparatus 151 can operate with a WFD mode which is an Autonomous GO mode. Moreover, the state in which the communication apparatus 151 is operating with the WFD mode is, specifically, for example, a state in which, while the connection using WFD is not yet established, the communication apparatus 151 is operating as a GO or a state in which the connection using WFD is currently established and the communication apparatus 151 is operating as a GO.

In the case of the software AP mode, between pieces of equipment which perform communication (for example, the information processing apparatus 101 and the communication apparatus 151), equipment on one side (for example, the information processing apparatus 101) serves as a client which plays the role of requesting various services. Then, equipment on the other side implements the function of an access point (AP) in Wi-Fi by setting of software. The software AP is equivalent to a master station in Wi-Fi, and the client is equivalent to a slave station in Wi-Fi. In the software AP mode, the client searches for equipment serving as a software AP with use of the equipment search information. When the software AP has been found, the client and the software AP perform the remaining processing operations for wireless connection (such as establishment of wireless connection) between them and, after that, perform processing operations for IP connection (such as allocation of IP addresses). Furthermore, with regard to commands and parameters which are transmitted and received in a case where wireless connection is implemented between the client and the software AP, the ones defined by the Wi-Fi standard can be used therefor, and the description thereof is omitted here.

In the present exemplary embodiment, in a case where the communication apparatus 151 is establishing and maintaining direct correction, the communication apparatus 151 operates as a master station within a network to which the communication apparatus 151 belongs. Furthermore, the master station is a device which builds a wireless network, and is a device which provides parameters used for connection to the wireless network to a slave station. The parameters used for connection to the wireless network are, for example, parameters related to channels which the master station uses. The slave station receives the parameters and thus uses the channels which the master station is using to connect to the wireless network which the master station is building. Since, in the direct connection mode, the communication apparatus 151 operates as a master station, the communication apparatus 151 is able to determine which frequency band to use for communication in the direct connection mode and which channel to use therefor. In the present exemplary embodiment, the communication apparatus 151 is assumed to be able to use, for communication in the direct connection mode, a channel corresponding to a frequency band of 2.4 gigahertz (GHz) and a channel corresponding to a frequency band of 5 GHz. Then, it is assumed that, by performing setting in a screen which the communication apparatus 151 displays, the user can optionally set which frequency band to use (i.e., the channel of which frequency band to use). However, in the present exemplary embodiment, it is assumed that, even if 5 GHz has been selected in a screen which the communication apparatus 151 displays, the communication apparatus 151 does not use a channel corresponding to a Dynamic Frequency Selection (DFS) band included in the frequency band of 5 GHz for communication in the direct connection mode. In other words, it is assumed that the communication apparatus 151 uses only channels corresponding to frequency bands other than the DFS band included in the frequency band of 5 GHz for communication in the direct connection mode. Furthermore, in a case where, in a state in which a channel corresponding to the DFS band is being used, a radar wave of a frequency band corresponding to the in-use channel has been detected, the channel currently in use has to be changed. Such a frequency band which may cause a change of channels by detection of a radar wave is referred to as a “DFS band”. Furthermore, for example, in a case where a wireless chip compatible with, for example, a Dynamic Frequency Selection (DFS) function is being used, a channel corresponding to the DFS band included in the frequency band of 5 GHz can be configured to be able to be used for communication in the direct connection mode.

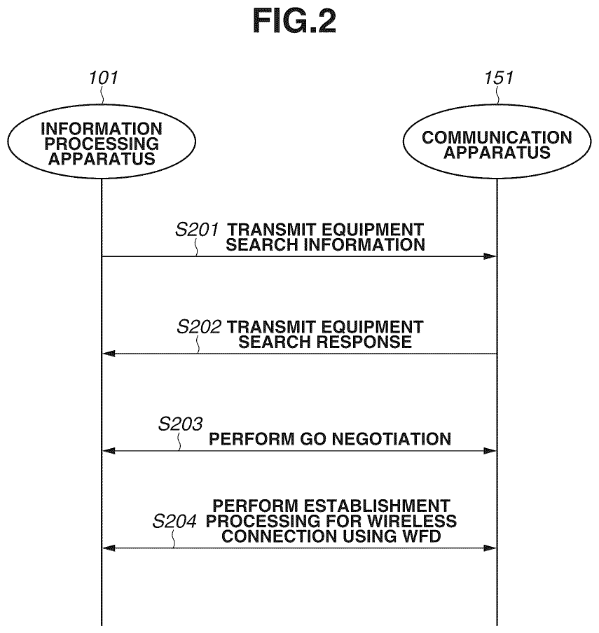

FIG. 2 is a diagram illustrating a wireless connection sequence in the WFD mode. Furthermore, processing which each apparatus performs in the present sequence is implemented by a CPU included in each apparatus reading out various programs stored in a memory such as a ROM included in each apparatus to a RAM and executing the read-out programs. Moreover, the present processing is assumed to be started in a case where, in a state in which each apparatus is launching a predetermined application for performing the WFD function, a predetermined operation for establishing a connection using WFD has been received from the user. Furthermore, the predetermined operation for establishing a connection using WFD is, for example, an operation of selecting a “direct connection mode enabling or disabling” button. Furthermore, such an operation is equivalent to an operation for starting the direct connection mode.

First, in step S201, the information processing apparatus 101 transmits equipment search information and searches for a device compatible with the WFD function as a communication partner device.

Next, in step S202, in a case where the received equipment search information is information which has been transmitted with use of the same channel as the channel currently used in the direct connection mode, the communication apparatus 151 transmits an equipment search response, which is a response to the equipment search information, to the information processing apparatus 101. This results in that the information processing apparatus 101 has found the communication apparatus 151 as a device compatible with the WFD function. Furthermore, after the information processing apparatus 101 has found the communication apparatus 151, processing operations in which each apparatus exchanges pieces of information about services and functions which each apparatus is able to supply can be performed between each apparatus.

Next, in step S203, the information processing apparatus 101 and the communication apparatus 151 perform GO Negotiation between them. After a client and a group owner are determined, the information processing apparatus 101 and the communication apparatus 151 exchange parameters for performing communication using WFD between them. Based on the exchanged parameters, the client and the group owner in P2P communication perform the remaining processing operations for wireless connection and for IP connection between them. Furthermore, as mentioned above, when the communication apparatus 151 operates with the Autonomous GO mode, the communication apparatus 151 can, without performing GO Negotiation, necessarily operate as a GO. Moreover, in a case where the communication apparatus 151 operates as a GO, the communication apparatus 151, serving as a master station, determines a frequency band and a channel for use in communication using WFD. Therefore, the communication apparatus 151 operating as a GO is able to select which frequency band to use out of 5 GHz and 2.4 GHz and which channel to use out of channels corresponding to the determined frequency band.

Next, in step S204, each apparatus performs establishment processing for wireless connection using WFD based on the exchanged parameters and by the channel determined by the GO.

### <Infrastructure Connection Method>

The infrastructure connection is a connection form in which pieces of equipment which perform communication (for example, the information processing apparatus 101 and the communication apparatus 151) connect to an access point (for example, the access point 131) which comprehensively controls a network for each piece of equipment and pieces of equipment perform communication between them via the access point. The communication apparatus 151 is also able to operate with a mode used for performing communication with use of infrastructure connection (infrastructure connection mode) as one of connection modes.

In the infrastructure connection, each piece of equipment searches for an access point with use of the equipment search information. When the access point has been found, the equipment and the access point perform the remaining processing operations for wireless connection (such as establishment of wireless connection) between them and, after that, perform processing operations for IP connection (such as allocation of IP addresses). Furthermore, with regard to commands and parameters which are transmitted and received in a case where wireless connection is implemented between the equipment and the access point, the ones defined by the Wi-Fi standard can be used therefor, and the description thereof is omitted here.

In the present exemplary embodiment, when the communication apparatus 151 operates with the infrastructure connection mode, the access point 131 operates as a master device and the communication apparatus 151 operates a slave device. Thus, in the present exemplary embodiment, the infrastructure connection refers to a connection between the communication apparatus 151 operating as a slave device and a device operating as a master device. In a case where the communication apparatus 151 is establishing infrastructure connection and the information processing apparatus 101 is also establishing infrastructure connection with the access point 131, a communication which is performed via the access point 131 is enabled between the communication apparatus 151 and the information processing apparatus 101. Since a channel for use in a communication in the infrastructure connection is determined by the access point 131, the communication apparatus 151 performs communication in the infrastructure connection with use of the channel determined by the access point 131. In the present exemplary embodiment, the communication apparatus 151 is assumed to be able to use a channel corresponding to a frequency band of 2.4 GHz and a channel corresponding to a frequency band of 5 GHz for communication in the infrastructure connection. Furthermore, the communication apparatus 151 is also able to use a channel corresponding to the DFS band included in a frequency band of 5 GHz for communication in the infrastructure connection. Furthermore, to perform communication with the communication apparatus 151 via the access point 131, the information processing apparatus 101 needs to recognize that the communication apparatus 151 belongs to a network which is formed by the access point 131 and to which the information processing apparatus 101 belongs.

Moreover, in a case where the information processing apparatus 101 and the communication apparatus 151 are connecting to the access point 131 by infrastructure connection, the communication apparatus 151 is enabled to be found by broadcasting which is performed by the information processing apparatus 101.

### <Software Configuration of Information Processing Apparatus 101>

Next, a software configuration of the information processing apparatus 101 in the present exemplary embodiment is described.

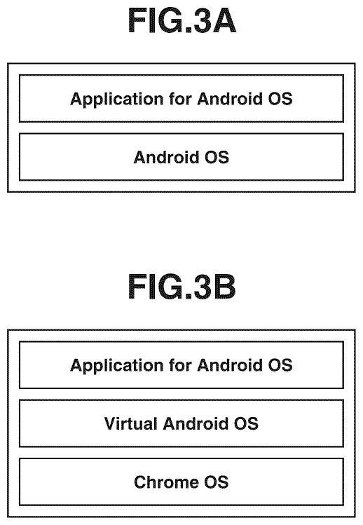

FIG. 3A illustrates an example of a software configuration of the information processing apparatus 101 in a case where the host OS running on the information processing apparatus 101 is an Android OS. In the present exemplary embodiment, an application for Android OS runs on the Android OS. In the present exemplary embodiment, a Chrome OS is assumed not to be included in the software configuration of the information processing apparatus 101. An environment in which, as in the present exemplary embodiment, the OS running in the lowermost layer of the information processing apparatus 101 is an Android OS (is not a Chrome OS) is hereinafter referred to as a “first environment” (also referred to as a “first operation environment” or a “real environment”). The first environment is, specifically, for example, an environment in which, while a host OS is installed on the information processing apparatus 101, a guest OS is not installed thereon and the communication application 400 is running on the host OS. Moreover, for example, the first environment is, specifically, for example, an environment in which, while both a host OS and a guest OS are installed on the information processing apparatus 101, the communication application 400 is running on the host OS and is running without via the guest OS (is not running on the guest OS). Furthermore, the host OS refers to a host operating system, and the guest OS refers to a guest operating system. Furthermore, the information processing apparatus 101 having the first environment and the information processing apparatus 101 having a second environment described below are assumed to be respective different information processing apparatuses 101. Thus, processing which is performed based on the communication application 400 running in the first environment, which is processing described below, is processing which is performed by the first information processing apparatus 101 having the first environment. Then, processing which is performed based on the communication application 400 running in the second environment is processing which is performed by the second information processing apparatus 101 having the second environment. However, for example, a state in which the first environment is built on one information processing apparatus 101 by installation or uninstallation of a host OS or guest OS being performed on such one information processing apparatus 101 and a state in which the second environment is built on such one information processing apparatus 101 can switch each other. Thus, both processing which is performed based on the communication application 400 running in the first environment and processing which is performed based on the communication application 400 running in the second environment can be performed on one information processing apparatus 101 based on an environment built in such one information processing apparatus 101.

FIG. 3B illustrates an example of a software configuration of the information processing apparatus 101 in a case where the host OS running on the information processing apparatus 101 is a Chrome OS. In the present exemplary embodiment, a virtual Android OS, which is a virtual OS, runs on the Chrome OS. Then, an application for Android OS runs on the virtual Android OS. An environment in which, as in the present exemplary embodiment, the OS running in the lowermost layer of the information processing apparatus 101 is a Chrome OS and a virtual Android OS runs on the Chrome OS is hereinafter referred to as a “second environment” (also referred to as a “second operation environment” or a “virtual environment”). Furthermore, in the present exemplary embodiment, the virtual OS is a program for causing an application incompatible with a host OS to run on the host OS, and is a guest OS. Furthermore, the virtual OS can be the entire existing OS such as an Android OS, can be a program obtained by omitting some modules from the entire existing OS, or can be a program created separately from the existing OS. Moreover, the virtual OS is implemented by, for example, a virtualization technique such as a virtual machine method or a container virtualization method.

Moreover, the virtual Android OS can be implemented by an emulator which entrusts functions such as resource management to a Chrome OS and provides an execution environment therefor to an Android application. In this case, the emulator itself is not an OS, but provides a virtual Android OS, including a Chrome OS, i.e., the second environment.

An issue occurring in the case of causing an application for Android OS to run in the second environment is described as follows. As one example, an example in which the above-mentioned communication application 400 has been installed in each of the first environment and the second environment and has been then executed is described. Furthermore, the communication application 400 has the function of communicating with the communication apparatus 151 having a printing function and performing printing of, for example, an image and, therefore, may be referred to as a “printing application”. Moreover, the Android OS may be referred to as “Android®”, and the Chrome OS may be referred to as “Chrome®”. Moreover, an application program developed in conformity with the Android OS in such a way as to be executed under the Android OS may be referred to as an “Android application”.

The communication application 400, which is an Android application in the present exemplary embodiment, provides the function of printing an image (hereinafter referred to as “photographic printing”), and, upon selection of the photographic printing function, displays, in an image list screen, icons of pieces of image data stored in a predetermined folder. Then, the communication application 400 transmits image data selected from the displayed icons to the communication apparatus 151, thus enabling performing printing.

Furthermore, in the present exemplary embodiment, there are assumed to be types of printers which the communication application 400 supports and types of printers which the communication application 400 does not support. The types of printers which the communication application 400 supports are, in other words, types of printers with which the communication application 400 is compatible. Then, the types of printers which the communication application 400 does not support are, in other words, types of printers with which the communication application 400 is incompatible. Then, the types of printers which the communication application 400 supports are assumed to be, specifically, all of the printers of models which perform printing in an inkjet method (inkjet printers), which a vendor which provides the communication application 400 provides, and a specific subset of printers of models which perform printing in an electrophotographic method (electrophotographic printers), which the vendor which provides the communication application 400 provides. The types of printers which the communication application 400 does not support are, specifically, printers other than the specific subset of printers of models which perform printing in an electrophotographic method, which the vendor which provides the communication application 400 provides.

Furthermore, the types of printers which the communication application 400 does not support may be supported by a different application which the vendor which provides the communication application 400 provides. Therefore, in a case where the user wants to transmit a job to a type of printer which the communication application 400 does not support, it is favorable that the different application is launched. Thus, in a case where, in a screen which the communication application 400 displays, the type of printer which the communication application 400 does not support has been selected, it is favorable that the communication application 400 performs processing for launching the different application.

However, the different application may be incompatible with the second environment and may be unable to run in the second environment. Thus, in the first environment, the different application is able to transmit a job to a type of printer which the different application supports, but, in the second environment, the different application may be unable to transmit a job even to a type of printer which the different application supports. Additionally, despite the fact that, in the second environment, even the different application is not able to transmit a job to a type of printer which the communication application 400 does not support, if the type of printer which the communication application 400 does not support is accidentally displayed in a selectable manner in the communication application 400, confusion may be caused for the user.

Therefore, in the present exemplary embodiment, control is performed in such a manner that, in the second environment, a type of printer which the communication application 400 does not support is not displayed in a selectable manner in the communication application 400. Specifically, control is performed in such a manner that, in the second environment, a type of printer which the communication application 400 does not support out of devices found by a search conducted by the communication application 400 is not displayed in a search result screen. With this configuration employed, it is possible to display, in a search result screen, only printers which are able to serve as a transmission destination for a job even in the second environment, and, thus, it is possible to preventing or reducing confusion from being caused for the user.

Moreover, conventionally, there has been a known method called a broadcast search as a method for the information processing apparatus 101 to search for a device which serves as a partner for communication using the communication application 400. The broadcast search is a method of finding a device by transmission of a broadcast search packet and reception of a response to the broadcast search packet. In the broadcast search, first, specifically, the communication application 400 executes a socket application programming interface (socket API). With this execution, the communication application 400 instructs an OS of the information processing apparatus 101 to perform transmission of a broadcast search packet. Then, the OS of the information processing apparatus 101 transmits the broadcast search packet to an access point (here, the access point 131) which is forming a network to which the information processing apparatus 101 belongs (is connecting).

The broadcast search packet is a packet in which a value for broadcast search which corresponds to not designating a transmission destination of the packet is set to a region in which IP addresses are stored. In the present exemplary embodiment, the content of the broadcast search packet is designated by the communication application 400. Thus, the device which is able to interpret the content of the broadcast search packet is a device compatible with the communication application 400. Then, the device compatible with the communication application 400 is, specifically, for example, a printing apparatus which is provided by a vendor of the communication application 400. In the present exemplary embodiment, the communication apparatus 151 is assumed to be a device compatible with the communication application 400. The access point 131, having received the broadcast search packet, transmits the received broadcast search packet to all of the devices belonging to a network which the access point 131 itself is forming. Then, in a case where a device which is able to interpret the broadcast search packet has received the broadcast search packet, the device transmits a response to the information processing apparatus 101, which is a transmission source of the broadcast search packet, via the access point 131. Then, the OS of the information processing apparatus 101 receives the response and then transmits the received response to the communication application 400. This enables the information processing apparatus 101 to find devices which have transmitted the respective responses, with use of the communication application 400, thus being able to perform processing that is based on a result of the broadcast search.

The processing that is based on a result of the broadcast search is, specifically, for example, processing for displaying a result of the broadcast search or processing for performing communication with the devices found by the broadcast search.

Moreover, there has been a known method called a multicast search as a method for the information processing apparatus 101 to search for a device which serves as a partner for communication using the communication application 400. The multicast search is a method of finding a device by transmission of a multicast search packet and reception of a response to the multicast search packet. In the multicast search, first, specifically, the communication application 400 executes a socket API, and thus instructs an OS of the information processing apparatus 101 to perform transmission of a multicast search packet. Then, the OS of the information processing apparatus 101 transmits the multicast search packet to an access point (here, the access point 131) which is forming a network to which the information processing apparatus 101 belongs (is connecting). The multicast search packet is a packet in which a value for multicast search which corresponds to designating a specific type of device as a transmission destination of the packet is set to a region in which IP addresses are stored. In the present exemplary embodiment, the content of the multicast search packet is designated by the communication application 400. Thus, the device which is able to interpret the content of the multicast search packet is a device compatible with the communication application 400. The access point 131, having received the multicast search packet, transmits the received multicast search packet to the type of device designated by the multicast search packet out of all of the devices belonging to a network which the access point 131 itself is forming. Then, in a case where a device which is able to interpret the multicast search packet has received the multicast search packet, the device transmits a response to the information processing apparatus 101, which is a transmission source of the multicast search packet, via the access point 131. Then, the OS of the information processing apparatus 101 receives the response and then transmits the received response to the communication application 400. This enables the information processing apparatus 101 to find devices which have transmitted the respective responses, with use of the communication application 400, thus being able to perform processing that is based on a result of the multicast search.

Furthermore, while the communication application 400 takes charge of designating the content of the broadcast search packet or the multicast search packet, the OS which runs in the lowermost layer in the information processing apparatus 101 takes charge of transmitting the broadcast search packet or the multicast search packet. Therefore, in an environment in which an application for Android OS runs in the second environment, the Chrome OS needs to conduct a broadcast search or a multicast search. However, in a case where an application for Android OS runs in the second environment, due to a firewall which the Chrome OS itself includes, the Chrome OS may perform control not to conduct a broadcast search or a multicast search in which the application for Android OS is an instruction source and a socket API has been used. As a result, there is an issue in which, in a case where the communication application 400 is running in the second environment, the communication application 400 may be unable to perform processing that is based on a result of the broadcast search or multicast search. Furthermore, a broadcast search or a multicast search in which an application for Chrome OS is an instruction source is not blocked by a firewall included in the Chrome OS. Therefore, in a case where the information processing apparatus 101 is causing the application for Chrome OS to run on the Chrome OS and an instruction to conduct a broadcast search or a multicast search has been issued by the socket API from the application for Chrome OS, the Chrome OS is able to conduct a broadcast search or a multicast search.

Moreover, in the present exemplary embodiment, the communication application 400 is compatible with a search for devices using WFD. Therefore, if the information processing apparatus 101 on which the communication application 400 is running is compatible with WFD, the communication application 400 instructs the OS of the information processing apparatus 101 to conduct a search for a device using WFD and receives a result of the search, thus being able to perform processing that is based on a result of the search.

However, a device with a Chrome OS installed thereon or the Chrome OS itself is often incompatible with WFD, so that it is often impossible to conduct a search for devices using WFD. There is an issue in which, in a case where the communication application 400 is running in the second environment, the communication application 400 may be unable to perform processing that is based on a result of a search for devices using WFD.

### <Configuration of Communication Application 400 (Communication App 400)>

FIG. 4 illustrates a configuration of the communication application 400, which is stored in, for example, the ROM 104 or the external storage device 106 included in the information processing apparatus 101. The communication application 400 is an application program having, for example, a printing function of causing the communication apparatus 151, which functions as a printer or a printing apparatus, to print, for example, image data or document data stored in the information processing apparatus 101. Moreover, the communication application 400 also has the function of taking, for example, image data or document data scanned by the communication apparatus 151 into the information processing apparatus 101.

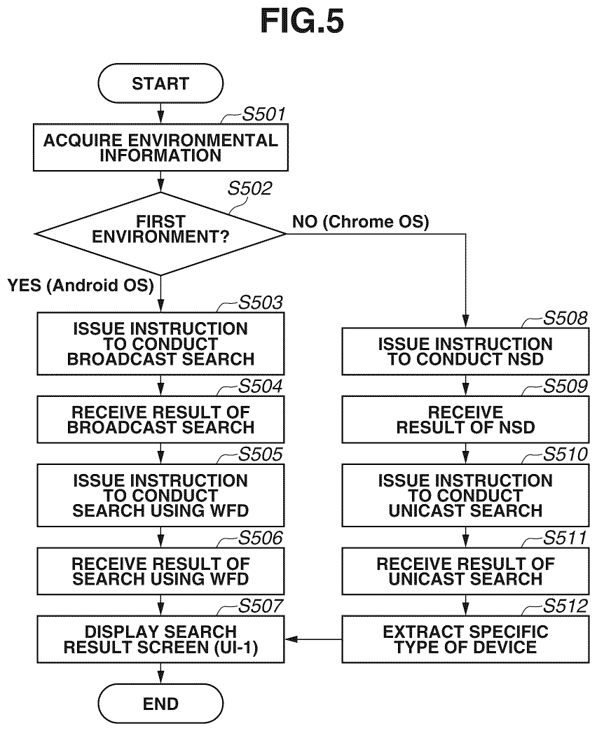

The communication application 400 includes an operation reception unit 401, an operation environment determination unit 402, a display control unit 403, a communication apparatus searching unit 404, an incompatible communication apparatus processing unit 405, a communication apparatus registration unit 406, and a printing control unit 407, which serve as program modules. The program modules are executed by the CPU 103, so that the respective functions thereof are implemented. In the present exemplary embodiment, the communication application 400 receives, via the operation reception unit 401, an operation which has been performed on the operation display unit 108. Moreover, the communication application 400 determines, via the operation environment determination unit 402, whether the current operation environment of the communication application 400 is the first environment, which is being provided by the Android OS, or the second environment, which is being provided by the virtual Android OS built on the Chrome OS. This determination can be performed based on a response obtained by inquiring of the OS, or can be performed by referring to a predetermined storage location. The operation environment determination unit 402 performs, for example, a determination in step S502 illustrated in FIG. 5 described below.

The display control unit 403 performs control of displaying which is performed on the operation display unit 108 by the communication application 400. Particularly, the display control unit 403 displays a list of printers (communication apparatuses 151) found by search as a search result screen on the operation display unit 108 of the information processing apparatus 101. Moreover, in a case where processing which is performed by the incompatible communication apparatus processing unit 405 described below is accompanied by displaying, the display control unit 403 also performs control of such displaying.

The communication apparatus searching unit 404 searches for (or looks up) a printer (communication apparatus 151) which is able to connect to the information processing apparatus 101 and is able to be used by the communication application 400, in a procedure such as that described below with reference to FIG. 5. The communication apparatus searching unit 404 functions as, for example, the information processing apparatus 101 in the procedure illustrated in FIG. 2, and thus searches for the communication apparatus 151.

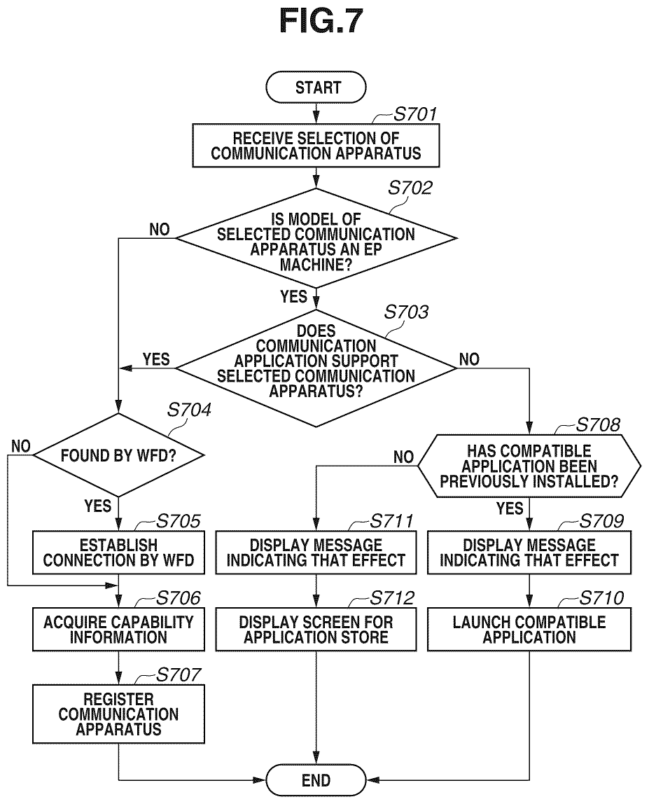

The communication apparatus registration unit 406 registers a communication apparatus 151 selected from among printers found by search, as a printer to be used by the communication application 400. Since then, the registered printer is able to be used without being searched for. The communication apparatus registration unit 406 performs, for example, a processing operation in step S707 illustrated in FIG. 7 described below.

The printing control unit 407 transmits data targeted for printing which is currently selected to a communication apparatus 151 which is currently selected, and causes the communication apparatus 151 to perform printing. The data targeted for printing can be, for example, document data or image data which is currently stored when the communication application 400 has been launched. Alternatively, the data targeted for printing can be data acquired from, for example, a cloud server or the communication apparatus 151. Moreover, the data targeted for printing can be data acquired from another data source.

Furthermore, in the following description, processing described as processing which the constituent elements illustrated in FIG. 4 and included in the communication application 400 perform is assumed to be, precisely, processing which is implemented by the CPU 103 reading out the communication application 400 stored in, for example, the ROM 104 to the RAM 105 and executing the read-out communication application 400. To perform printing, the printing control unit 407 generates a print job and then transmits the print job to the communication apparatus 151 (i.e., a printer). The communication apparatus 151 executes the received print job, thus performing printing. Moreover, in the present exemplary embodiment, a device which the communication application 400 is able to set as a transmission destination of a job is assumed to be a device which is currently registered with the communication application 400. In other words, it is assumed that, if a device is not registered with the communication application 400, the communication application 400 is unable to transmit the job.

### <Search for Device by Communication Application 400>

FIG. 5 is a flowchart illustrating a search for a device by the communication application 400 in the present exemplary embodiment. Furthermore, processing in the present flowchart is implemented by the CPU 103 reading out various programs stored in a memory such as the external storage device 106 to the RAM 105 and then executing the read-out various programs. Specifically, the processing in the present flowchart is implemented by the communication application 400 being executed. Particularly, the processing in the present flowchart is equivalent to a processing operation to be performed by the communication apparatus searching unit 404. Moreover, the present processing is assumed to be started in a case where an operation serving as a trigger for a search for a device has been performed by the user in a screen which the communication application 400 displays. Furthermore, the present exemplary embodiment is not limited to this configuration, and, for example, the present processing can be started based on the communication application 400 having been launched.

In step S501, the CPU 103 acquires environmental information about an environment in which the communication application 400 is running, by executing an API of the Android OS via the communication application 400. In a case where the environment in which the communication application 400 is running is the first environment, information corresponding to the first environment is acquired as the environmental information. On the other hand, in a case where the environment in which the communication application 400 is running is the second environment, the above-mentioned API to be executed is an API of the virtual Android OS and information corresponding to the second environment is acquired as the environmental information.

In step S502, the CPU 103 determines whether the environment in which the communication application 400 is running is the first environment, based on the environmental information acquired in step S501. If the result of this determination is YES (YES (Android OS) in step S502), the CPU 103 advances the processing to step S503, and, if the result of this determination is NO (NO (Chrome OS) in step S502), the CPU 103 advances the processing to step S508.

In step S503, the CPU 103 determines, via the communication application 400, the content of a broadcast search packet. Then, the CPU 103 instructs, via the communication application 400, the Android OS to transmit a broadcast search packet having the determined content, by executing the socket API via the communication application 400. Thus, the CPU 103 performs a processing operation for broadcast search via the communication application 400. As such, the CPU 103 performs transmission of the broadcast search packet to the access point 131 by the Android OS. Moreover, in the present exemplary embodiment, the broadcast search packet is assumed to be configured in such a manner that only a device compatible with the communication application 400 is able to respond to the broadcast search packet. Moreover, in the present exemplary embodiment, a plurality of types of broadcast search packets is assumed to be broadcast. The plurality of types of broadcast search packets includes, specifically, a type of packet configured in such a manner that only an inkjet printer is able to respond thereto and a type of packet configured in such a manner that only an electrophotographic printer is able to respond thereto. Furthermore, a type of packet configured in such a manner that only an old model of printer out of inkjet printers is able to respond thereto or a type of packet configured in such a manner that only a new model of printer out of inkjet printers is able to respond thereto can be included. Specifically, for example, the CPU 103 performs control to make devices targeted for search different from each other by making port numbers set in the broadcast search packet different from each other. This enables the broadcast search to find only a desired device.

Then, it is possible to discriminate which device (for example, which of an inkjet printer and an electrophotographic printer) the device found by the broadcast search is.

In step S504, the CPU 103 acquires a response to the broadcast search packet from the Android OS via the communication application 400. With this acquisition, the CPU 103 identifies the device serving as a transmission source of the response as a device found by the broadcast search. The response includes information indicating whether the inquiry is successful and the type (such as a printer) and model name of the device. Moreover, the response can include, for example, an IP address or a medium access control (MAC) address of the communication apparatus.

Furthermore, while, in the above description, a configuration in which a processing operation for broadcast search is performed in step S503 and step S504 has been described, a configuration in which a processing operation for multicast search is performed in those steps can be employed. Thus, in step S503, the CPU 103 can determine, via the communication application 400, the content of a multicast search packet and instruct, via the communication application 400, the Android OS to transmit a multicast search packet having the determined content, by executing the socket API via the communication application 400. Then, in step S504, the CPU 103 can acquire a response to the multicast search packet from the Android OS via the communication application 400.

In step S505, the CPU 103 instructs, via the communication application 400, the Android OS to conduct a search using WFD (i.e., transmit equipment search information using WFD), by executing an API for WFD. As such, the CPU 103 performs transmission of the equipment search information by the Android OS. Then, after that, the Android OS receives an equipment search response from WFD-compatible devices present in the vicinity of the information processing apparatus 101. The present processing operation corresponds to the processing operation in step S201 or step $202 illustrated in FIG. 2.

In step S506, the CPU 103 acquires the equipment search response from the Android OS via the communication application 400. With this acquisition, the CPU 103 identifies the device serving as a transmission source of the equipment search response as a device found by the search using WFD. Furthermore, at this time, the CPU 103 can identify only a device compatible with a printing service, out of devices serving as a transmission source of the equipment search response, as a device found by the search using WFD. Which device is compatible with which service is able to be confirmed by a communication performed between the device serving as a transmission source of the equipment search response and the information processing apparatus 101.

In step S507 which is performed after step S506, the CPU 103 displays, via the communication application 400, a search result screen, which is a screen showing a list of one or a plurality of devices found by the broadcast search and one or a plurality of devices found by the search using WFD. The respective devices to be displayed in the search result screen are based on pieces of information acquired in step S504 and step S506. Alternatively, in a case where the processing branches from step S502 into step S508, the respective devices to be displayed in the search result screen are based on information indicating a device extracted in step S512 described below out of information acquired in step S509 described below or information acquired in step S511 described below. Furthermore, in the search result screen, the above-mentioned list can be displayed in such a manner that one or a plurality of devices found by the broadcast search and one or a plurality of devices found by the search using WFD are distinguishable from each other. Specifically, for example, in the search result screen, to a display item corresponding to a device found by the broadcast search, an icon corresponding to the device being a device found by the broadcast search can be appended. Moreover, likewise, in the search result screen, to a display item corresponding to a device found by the search using WFD, an icon corresponding to the device being a device found by the search using WFD can be appended. Moreover, in the search result screen, the above-mentioned list can be displayed in such a manner that an inkjet printer and an electrophotographic printer are distinguishable from each other. Then, the CPU 103 receives selection of any one device out of the devices displayed in the search result screen from the user via the communication application 400.

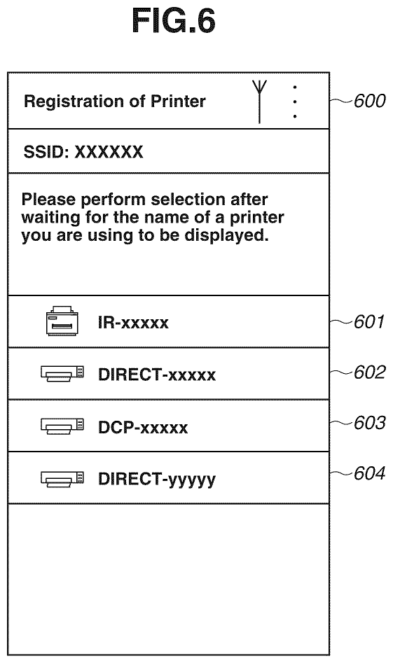

FIG. 6 illustrates an example of displaying performed in step S507. On the operation display unit 108 of the information processing apparatus 101, a screen 600, which is the search result screen, is displayed. In the screen 600, the title is displayed as “Registration of Printer”. Additionally, in the screen 600, a list of printers (communication apparatuses) found by searches in the processing illustrated in FIG. 5 is displayed. Items 601 to 604 correspond to the respective found printers, and, in each item, identification information about a printer corresponding to each item is displayed. The identification information to be displayed here is, for example, a model name, but can be different information such as a service set identifier (SSID) or a MAC address. Moreover, here, as mentioned above, mutually different icons are displayed in such a manner that an inkjet printer and an electrophotographic printer are distinguishable from each other. Furthermore, this distinction can be identified based on, for example, a model name received as a search response. The user is allowed to perform selection by performing an operation such as tapping a field for a desired printer from the displayed list of printers. Furthermore, as mentioned above, depending on which of the first environment and the second environment the operation environment of the communication application 400 is, a method for a search to be performed or a printer to be identified as a display target in the search result screen out of the found printers differs. Therefore, a printer to be displayed in the screen 600 differs depending on which of the first environment and the second environment the operation environment of the communication application 400 is.

If the result of the determination in step S502 is NO (NO (Chrome OS) in step S502), i.e., in a case where the current operation environment is the second environment, the CPU 103 causes the processing to branch into step S508. In step S508, the CPU 103 performs, via the communication application 400, a processing operation for searching for devices present on a network to which the information processing apparatus 101 belongs, with use of an API different from the socket API. Specifically, the API to be used here is a network service discovery (NSD) API. The present API being executed via the communication application 400 causes a search called “NSD” to be conducted. NSD is a multicast search which is executed with a DNS-based service discovery protocol being used. Moreover, NSD is a search which is able to be conducted by an instruction from the communication application 400 even in the second environment. In the present processing operation, specifically, if the present API is executed via the communication application 400, the virtual Android OS instructs the Chrome OS to conduct NSD. Then, the Chrome OS conducting NSD causes a device which is present on a network to which the information processing apparatus 101 belongs and is compatible with NSD to be found. Furthermore, in executing the NSD API, the communication application 400 is able to designate a device compatible with which service to search for by NSD. Furthermore, the designation of a service is performed by, for example, the designation of a protocol. Therefore, in the present exemplary embodiment, the communication application 400 designates searching for a device (i.e., a printer) compatible with a printing service, by designating the Internet Printing Protocol (IPP).

Furthermore, while, in a search instruction using the socket API, the communication application 400 designates an IP address as the designation of a device serving as a transmission destination for a packet, in a search instruction using the NSD API, the communication application 400 does not perform the designation of an IP address.

Next, in step S509, the CPU 103 acquires, via the communication application 400, information about the found device as a result of the search using NSD. The information to be acquired here is, specifically, for example, an IP address, port number, and service name of the found device.

Next, in step S510, the CPU 103 performs a processing operation for conducting a unicast search while targeting one or a plurality of devices found by NSD. Furthermore, while, in the present exemplary embodiment, a processing operation for conducting a unicast search on all of the devices found by NSD is assumed to be performed, the present exemplary embodiment is not limited to this configuration. A processing operation for conducting a unicast search on some devices out of the devices found by NSD can be performed. The unicast search is a method of designating a device targeted for search by an IP address and searching for the designated device on a network to which the information processing apparatus 101 belongs. Since the IP address of a device found by NSD has been acquired as a result of the search using NSD by the communication application 400, it is possible to re-search for the device found by NSD by a unicast search. Furthermore, in the case of a broad search, the inside of a subnetwork to which the information processing apparatus 101 belongs is a search target range. On the other hand, in the case of a unicast search, not only the inside of a subnetwork to which the information processing apparatus 101 belongs but also the inside of another subnetwork connected to the first-mentioned subnetwork becomes a search target range. Furthermore, the term “subnetwork” refers to a unit included in one network configured with one access point. Furthermore, the unicast search is a search which is able to be conducted by an instruction from the communication application 400 even in the second environment. In the present processing operation, specifically, the CPU 103 determines the content of a unicast search packet via the communication application 400. Then, the CPU 103 instructs, via the communication application 400, the virtual Android OS to transmit a unicast search packet having the determined content, by executing the socket API. Furthermore, the unicast search packet is a packet in which a value for unicast search which corresponds to designating a transmission destination of the unicast search packet (in other words, the address of a search target device) is set to a region in which IP addresses are stored. Moreover, in the present exemplary embodiment, the unicast search packet is assumed to be configured in such a manner that only a device compatible with the communication application 400 is able to respond to the unicast search packet. Moreover, in the present exemplary embodiment, a plurality of types of unicast search packets are assumed to be transmitted to one device. The plurality of types of unicast search packets includes, specifically, a type of packet configured in such a manner that only an inkjet printer is able to respond thereto and a type of packet configured in such a manner that only an electrophotographic printer is able to respond thereto. Furthermore, a type of packet configured in such a manner that only an old model of printer out of inkjet printers is able to respond thereto or a type of packet configured in such a manner that only a new model of printer out of inkjet printers is able to respond thereto can be included. This enables the unicast search to find only a desired device. Then, it is possible to discriminate which device (for example, which of an inkjet printer and an electrophotographic printer) the device found by the unicast search is. In the present exemplary embodiment, the content of a unicast search packet is assumed to differ from the content of a broadcast search packet only in an IP address indicating the transmission destination of the packet. After that, the virtual Android OS instructs the Chrome OS to conduct a unicast search. Then, the Chrome OS conducts a unicast search by transmitting a unicast search packet. With this search, a response is received from a device which is present on a network to which the information processing apparatus 101 belongs and which corresponds to the IP address designated in the unicast search packet, so that the device is found by the unicast search.

Next, in step S511, the CPU 103 acquires, via the communication application 400, information about the device found by the unicast search as a result of the unicast search. The information to be acquired here is, specifically, for example, the IP address, MAC address, model name (equipment type name), or serial number of the found device. The unicast search being conducted after NSD enables identifying a device compatible with the communication application 400 out of devices found by NSD. Moreover, the unicast search being conducted after NSD also enables acquiring information which has not been able to be acquired by NSD.

Next, in step S512, the CPU 103 extracts (identifies) a specific type of device from the result of the unicast search obtained in step S511. In the present exemplary embodiment, the specific type of device is the above-mentioned type of printer which the communication application 400 supports. Therefore, a printer which is not extracted in the present processing operation is a type of printer which the communication application 400 does not support out of the devices found by the unicast search. Furthermore, the present exemplary embodiment is not limited to this configuration, and the type of printer which the communication application 400 supports can be some printers out of types of printers each of which performs printing in the inkjet method, which a vendor which provides the communication application 400 provides. Furthermore, the communication application 400 preliminarily retains identification information for discriminating a type of printer which the communication application 400 supports, and performs the present determination based on the retained identification information. Furthermore, the identification information is, specifically, for example, a model name.

Then, in step S507 which is performed after step S512, the CPU 103 displays, via the communication application 400, a search result screen, which is a screen showing a list of devices extracted in step S512 out of the devices found by the unicast search. Thus, control is performed in such a manner that, even if a specific type of device has been found by a unicast search, a search result screen which does not include the specific type of device is displayed. Employing this configuration enables preventing or reducing a device which is unable (unlikely) to be registered as a transmission destination of a job by an application compatible with the second environment from being selected in the second environment. Furthermore, in the search result screen, the above-mentioned list can be displayed in such a manner that an inkjet printer and an electrophotographic printer are distinguishable from each other. Then, the CPU 103 receives selection of any one device out of the devices displayed in the search result screen from the user via the communication application 400. Furthermore, in a case where a type of printer which the communication application 400 does not support is included in the result of the unicast search obtained in step S511, a message indicating that a type of printer which the communication application 400 does not support has been found can be displayed in, for example, the search result screen via the communication application 400. Moreover, using a printing function which the Chrome OS provides may enable transmitting a job in the second environment even to a type of printer which the communication application 400 does not support. Therefore, a message for guiding the user to the effect that using a printing function which the Chrome OS provides may enable causing a type of printer which the communication application 400 does not support to perform printing can be displayed in, for example, the search result screen via the communication application 400. Furthermore, the printing function which the Chrome OS provides is implemented by a printing application program equipped as standard in the host OS (here, the Chrome OS). The printing application program equipped as standard in the host OS is a program preliminarily installed on the information processing apparatus 101 since the arrival of shipment of the information processing apparatus 101 as with the host OS. In other words, the printing application program equipped as standard in the host OS is an application which is not installed by a store application which is an application for installing various applications on the information processing apparatus 101 via the Internet. Then, the printing function which the Chrome OS provides is a function which is implemented with use of the Internet Printing Protocol (IPP). Specifically, for example, in the printing function which the Chrome OS provides, searching for a printer serving as a target for transmission of a print job or transmission of a print job is performed by the IPP. Therefore, the printing application program equipped as standard in the host OS is a program for performing the above-mentioned processing operation with use of the IPP.

In this way, the procedure illustrated in FIG. 5 switches whether to conduct a broadcast search, based on an environment in which the communication application 400 runs. Specifically, based on the environment in which the communication application 400 runs being the first environment, the procedure illustrated in FIG. 5 conducts a broadcast search and, based on the environment in which the communication application 400 runs being the second environment, the procedure illustrated in FIG. 5, without conducting a broadcast search, performs a different processing operation. The different processing operation includes, specifically, for example, conducting a search using NSD and conducting a unicast search. Moreover, based on the environment in which the communication application 400 runs, the procedure illustrated in FIG. 5 switches between displaying all of the printers found by the search in a search result screen and displaying only types of printers which the communication application 400 supports out of the printers found by the search in a search result screen. This enables the communication application 400 to perform appropriate processing that is based on the environment in which the communication application 400 runs.

Furthermore, the communication application 400 determines which of a broadcast search, a multicast search, and a unicast search to designate, depending on an IP address which is designated at the time of execution of the socket API. Thus, the communication application 400 determines which search to designate depending on designating an address having which content as an IP address included in a packet which is transmitted for the search. Therefore, the present exemplary embodiment is, in other words, a configuration of, based on the environment in which the communication application 400 runs, switching the content of an IP address which is designated in a packet used for the search.

Furthermore, the processing operation which is performed based on the environment in which the communication application 400 runs being the second environment is not limited to the above-mentioned operation. Such a processing operation can be a processing operation of displaying a notification screen for notifying the user that it is impossible to conduct a broadcast search.

Then, in a configuration in which the notification screen is displayed, a search using NSD or a unicast search does not need to be conducted. Moreover, the notification screen can also be a screen for notifying the user that the environment in which the communication application 400 runs is the second environment or a screen for notifying the user that a communication apparatus is unable to be registered with the communication application 400. Additionally, the notification screen can also be a screen for prompting the user to cause the communication application 400 to run in the first environment.

Moreover, the method for search is not limited to the above-mentioned method. For example, the sequential order in which processing operations for a broadcast search (step S503 and step S504) and processing operations for a search using WFD (step S505 and step S506) are performed can be reversed, or the respective searches can be conducted in parallel. Moreover, a configuration in which, instead of the search result screen being displayed after each of the searches ends, each time a device is found by each search, the found device is progressively added to the search result screen can be employed.

Moreover, the communication application 400 can be configured to be able to receive each of an operation for issuing an instruction to conduct a broadcast search and an operation for issuing an instruction to conduct a search using WFD separately from each other. Then, in a case where the operation for issuing an instruction to conduct a broadcast search has been performed, the processing in the flowchart of FIG. 5 can be performed without the processing operation for a search using WFD being performed. Moreover, likewise, in a case where the operation for issuing an instruction to conduct a search using WFD has been performed, the processing in the flowchart of FIG. 5 can be performed without the processing operation for a broadcast search being performed. Moreover, the communication application 400 can be an application which is compatible with only one of a broadcast search and a search using WFD. Thus, in a case where the communication application 400 is an application which is compatible with only a broadcast search, the processing in the flowchart of FIG. 5 can be performed without the processing operation for a search using WFD being performed. Likewise, in a case where the communication application 400 is an application which is compatible with only a search using WFD, the processing in the flowchart of FIG. 5 can be performed without the processing operation for a broadcast search being performed.

Moreover, while, in the above description, a configuration in which processing operations for a unicast search (step S510 and step S511) are performed after processing operations for NSD (step S508 and step S509) has been described, the present exemplary embodiment is not limited to this configuration. For example, a configuration in which, instead of the processing operations for a unicast search being performed in the flowchart of FIG. 5, types of printers which the communication application 400 supports out of the devices found by NSD are displayed in the search result screen can be employed. Furthermore, a configuration in which, at this time, the types of printers which the communication application 400 supports store information corresponding to being types of printers which the communication application 400 supports as a response to NSD can also be employed. Thus, a configuration in which only devices identified or extracted as types of printers which the communication application 400 supports out of the devices found by NSD are displayed in the search result screen can also be employed.

### <Registration Processing for Printer (Communication Apparatus)>

FIG. 7 illustrates an example of processing for registering a printer selected from among one or a plurality of printers displayed in the screen illustrated in FIG. 6. As mentioned above, without the need to search for the registered printer each time the registered printer is used, it is possible to perform printing using the registered printer. However, this is naturally true on the condition that the information processing apparatus 101 has been able to connect to the printer serving as the communication apparatus 151, and, if such a connection is unsuccessful, the information processing apparatus 101 needs to search for a new printer or try to use another registered printer.

Referring to FIG. 7, in step S701, the CPU 103 receives selection of a printer in the search result screen displayed in step S507. Then, in step S702, the CPU 103 determines whether the model of the printer selected in step S701 is a model which performs printing in the electrophotographic (EP) method, i.e., an EP machine. The EP machine is, in other words, an electrophotographic printer. For example, a printer of the model which performs printing in the inkjet (IJ) method is determined not to be an EP machine.

The printer of the model which performs printing in the inkjet (IJ) method is, in other words, an IJ machine, i.e., an inkjet printer. This determination can be performed based on information indicating the model, such as a model name included in a response received from the printer as a search result. In that case, the communication application 400 can retain information about a model name and information indicating whether the printer is an EP machine, and can perform determination by referring to such pieces of information.

If, in step S702, it is determined that the model of the selected printer is a model which performs printing in the electrophotographic method (YES in step S702), then in step S703, the CPU 103 determines whether the communication application 400 supports (i.e., is compatible with) the printer selected in step S701. In the present exemplary embodiment, the type of printer which the communication application 400 supports is assumed to include all of the types of printers each of which performs printing in the inkjet method, which a vendor which provides the communication application 400 provides, and some printers out of types of printers each of which performs printing in the electrophotographic method, which a vendor which provides the communication application 400 provides. Furthermore, the present exemplary embodiment is not limited to this configuration, and the type of printer which the communication application 400 supports can include some printers out of types of printers each of which performs printing in the inkjet method, which a vendor which provides the communication application 400 provides. In the case of that configuration, the CPU 103 can omit the determination in step S702, and can advance the processing to step S703 immediately after step S701. Furthermore, the communication application 400 preliminarily retains information about, for example, a model name of the printer which the communication application 400 supports, and performs the present determination by referring to such information. Furthermore, in the present exemplary embodiment, as mentioned above, control is performed in such a manner that, in the second environment, a printer which the communication application 400 does not support is not displayed in the search result screen. Therefore, in the second environment, there is no case where the result of the determination in step S703 is NO. Therefore, in the second environment, there is no case where processing operations in step S708 to step S712 described below are performed.

If the result of the determination in step S702 is NO (NO in step S702) or if the result of the determination in step S703 is YES (YES in step S703), then in step S704, the CPU 103 determines whether the selected printer is a printer found by WFD. The printer found by WFD is a printer found by the processing operations in step S505 and step S506 illustrated in FIG. 5. A printer found by a method other than WFD is a printer found by the processing operations in step S503, step S504, and step S508 to step S511 illustrated in FIG. 5. If it is determined that the selected printer is a printer found by WFD (YES in step S704), then in step S705, the CPU 103 establishes a connection between the selected printer and the information processing apparatus 101 by WFD. If it is not determined that the selected printer is a printer found by WFD (NO in step S704) or after the selected printer and the information processing apparatus 101 have connected to each other by WFD (in step S705), then in step S706, the CPU 103 acquires capability information (information about ability) from the selected printer. The acquisition of capability information is performed via a connection between the selected printer and the information processing apparatus 101. Thus, if the result of the determination in step S704 is YES, the acquisition of capability information is performed via a connection using WFD between the selected printer and the information processing apparatus 101. Then, if the result of the determination in step S704 is NO, the acquisition of capability information is performed via an infrastructure connection between the selected printer and the information processing apparatus 101. Thus, the acquisition of capability information is performed via an access point to which the information processing apparatus 101 is connecting. After that, in step S707, the CPU 103 stores the acquired information in the communication application 400, and thus registers the selected printer (communication apparatus), which is a printer corresponding to the acquired information, with the communication application 400. The information to be registered can be, for example, a name of the printer, an address serving as a connection destination, and the acquired capability information. The printer being registered with the communication application 400 enables the communication application 400 to transmit various jobs, such as a print job and a scan job, to the registered printer.

If the result of the determination in step S703 is NO (NO in step S703), then in step S708, the CPU 103 determines whether a different application (program) which is other than the communication application 400 and is compatible with the selected printer has been previously installed. In the present exemplary embodiment, in Android applications which are executed in the first environment, there is a different application (second application) which the communication application 400 does not support but which supports a printer provided by the same vendor as the vendor of the communication application 400. The different application is an application provided by the same vendor as the vendor of the communication application 400.

Moreover, the different application is able to register, with the different application itself, a printer which is provided by the same vendor as the vendor of the communication application 400 but with which the communication application 400 is not compatible.

Thus, the different application is able to transmit a print job or a scan job to a printer which is provided by the same vendor as the vendor of the communication application 400 but with which the communication application 400 is not compatible. Therefore, even if the communication application 400 itself is incompatible with the selected printer, the communication application 400 determines whether the different application compatible with the selected printer has been previously installed.

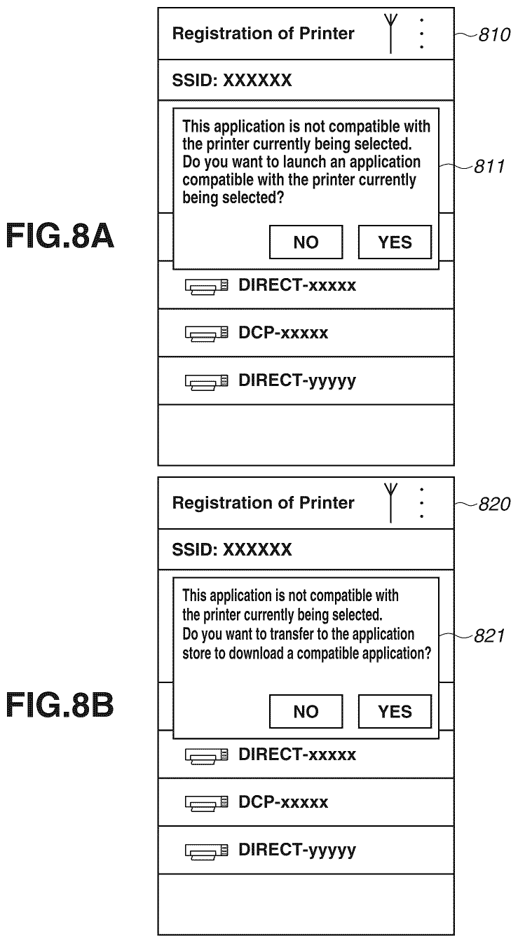

If it is determined that the compatible different application has been previously installed (YES in step S708), then in step S709, the CPU 103 displays a screen 810 including a message 811 indicating that effect. FIG. 8A illustrates an example of the screen 810 including the message 811. The message 811 includes information indicating that the communication application 400 currently being executed is incompatible with (does not support) the selected printer and further includes buttons used to receive selection as to whether to launch a compatible different application. If the user selects the button “YES”, i.e., launching the different application (i.e., the different program), then in step S710, the CPU 103 launches the compatible different application. Since, after that, an operation screen for the launched application is displayed, the user can operate the operation screen to cause, for example, an image targeted for printing to be printed. Furthermore, in a case where the present processing operation is performed, the communication application 400 can end the processing without registering the selected printer.

On the other hand, if it is determined that no application compatible with the selected printer has been previously installed (NO in step S708), then in step S711, the CPU 103 displays a screen 820 including a message 821 indicating that effect. FIG. 8B illustrates an example of the screen 820 including the message 821. The message 821 includes information indicating that the communication application 400 currently being executed is incompatible with (does not support) the selected printer and further includes buttons used to receive selection as to whether to install a compatible different application. To install the application, it is necessary to download the application from an application store which provides the application. Therefore, the message 821 also includes a confirmation of transferring to the application store. The transferring to the application store is that the communication application 400 connects to an application store which the communication application 400 knows in advance and then displays a screen for the application store. If the user selects the button “YES”, i.e., installation of the different application, then in step S712, the CPU 103 launches the application store for the different application and displays a screen for the application store. After that, the user performs an operation of downloading the compatible application from the application store and installing the downloaded application.

After the completion of installation, the CPU 103 can directly launch the installed application. In that case, since an operation screen for the launched application is displayed, the user can operate the operation screen to cause, for example, an image targeted for printing to be printed. Furthermore, in a case where the present processing operation is performed, the communication application 400 can end the processing without registering the selected printer.

As described above, according to the present exemplary embodiment, it is possible to search for a printer with methods (or protocols) corresponding to the respective operation environments including the first environment and the second environment. This enables searching for a printer which is able to connect to an information processing apparatus which is executing the communication application 400, irrespective of the operation environment of the communication application 400. Moreover, it is possible to display a search result screen with display methods corresponding to the respective operation environments including the first environment and the second environment.

The present disclosure can also be implemented by processing for supplying a program for implementing one or more functions of the above-described exemplary embodiment to a system or apparatus via a network or a storage medium and causing one or more processors included in a computer of the system or apparatus to read out and execute the program. Moreover, the functions of the above-described exemplary embodiment can also be implemented by a circuit which implements one or more functions of the above-described exemplary embodiment (for example, an application specific integrated circuit (ASIC)).

The present disclosure is not limited to the above-described exemplary embodiment, but can be altered or modified in various manners without departing from the spirit and scope of the present disclosure. Accordingly, claims are accompanied to address the scope of the present disclosure publicly.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-009688 filed Jan. 25, 2024, which is hereby incorporated by reference herein in its entirety.

What is claimed is:

1. A control method for a first information processing apparatus including a predetermined program capable of running on an operating system (OS) and including a first operation environment present on a first OS running as a host OS but not present on a guest OS and a second information processing apparatus including the predetermined program and including a second operation environment present on a second OS running as the host OS and present on the guest OS, the control method comprising:
displaying, on a first screen in the first information processing apparatus, one or a plurality of communication apparatuses found by a search conducted based on an instruction issued by the predetermined program running in the first operation environment;
receiving, in the first information processing apparatus, selection of any one communication apparatus from among the one or the plurality of communication apparatuses displayed on the first screen;
preforming, in a case where the communication apparatus selected from among the one or the plurality of communication apparatuses displayed on the first screen is a communication apparatus incompatible with the predetermined program, processing related to another program different from the predetermined program in the first information processing apparatus;
displaying, on a second screen in the second information processing apparatus, one or a plurality of communication apparatuses found by a search conducted based on an instruction issued by the predetermined program running in the second operation environment;
receiving, in the second information processing apparatus, selection of any one communication apparatus from among the one or the plurality of communication apparatuses displayed on the second screen;
performing control in such a manner that, even in a case where a communication apparatus incompatible with the predetermined program is included in the one or the plurality of communication apparatuses found by the search conducted by the first information processing apparatus, the one or the plurality of communication apparatuses including the communication apparatus incompatible with the predetermined program is displayed on the first screen; and
performing control in such a manner that, in a case where a communication apparatus incompatible with the predetermined program is included in the one or the plurality of communication apparatuses found by the search conducted by the second information processing apparatus, the one or the plurality of communication apparatuses not including the communication apparatus incompatible with the predetermined program is displayed on the second screen.

2. The control method according to claim 1, further comprising:
registering, in a case where the communication apparatus selected from among the one or the plurality of communication apparatuses displayed on the first screen is a communication apparatus compatible with the predetermined program, the communication apparatus selected from among the one or the plurality of communication apparatuses displayed on the first screen with the predetermined program in the first information processing apparatus;
transmitting, in the first information processing apparatus, data to the communication apparatus registered with the predetermined program;
registering the communication apparatus selected from among the one or the plurality of communication apparatuses displayed on the second screen with the predetermined program in the second information processing apparatus; and
transmitting, in the second information processing apparatus, data to the communication apparatus registered with the predetermined program.

3. The control method according to claim 2, wherein the data to be transmitted to the communication apparatus registered with the predetermined program is a print job for causing the communication apparatus registered with the predetermined program to perform printing or a scan job for causing the communication apparatus registered with the predetermined program to perform scanning.

4. The control method according to claim 1, wherein the processing related to the another program is processing for launching the another program.

5. The control method according to claim 1, wherein, in a case where the another program is not currently installed on the first information processing apparatus, the processing related to the another program is processing for launching a store application program for installing the another program.

6. The control method according to claim 1, wherein the another program is a program capable of transmitting data to a communication apparatus incompatible with the predetermined program.

7. The control method according to claim 1, wherein the another program is a program which is provided by a vendor which provides the predetermined program.

8. The control method according to claim 1, wherein a communication apparatus compatible with the predetermined program includes at least one of a set of inkjet printers each of which performs printing in an inkjet method and a set of some models of electrophotographic printers each of which performs printing in an electrophotographic method.

9. The control method according to claim 1, wherein a communication apparatus incompatible with the predetermined program includes some models of electrophotographic printers each of which performs printing in an electrophotographic method.

10. The control method according to claim 1, wherein the search which is conducted based on an instruction issued by the predetermined program running in the first operation environment and the search which is conducted based on an instruction issued by the predetermined program running in the second operation environment are different from each other.

11. The control method according to claim 1, wherein the search which is conducted based on an instruction issued by the predetermined program running in the first operation environment includes a broadcast search or a multicast search which is conducted by a socket application programming interface (API).

12. The control method according to claim 1, wherein the search which is conducted based on an instruction issued by the predetermined program running in the first operation environment includes a search using Wi-Fi Direct®.

13. The control method according to claim 1, wherein the search which is conducted based on an instruction issued by the predetermined program running in the second operation environment includes a search which is conducted by an application programming interface (API) different from a socket API.

14. The control method according to claim 13, wherein the API different from the socket API is a network service discovery API.

15. The control method according to claim 1, wherein the search which is conducted based on an instruction issued by the predetermined program running in the second operation environment includes a unicast search which is conducted by a socket application programming interface (API).

16. The control method according to claim 1, wherein, in each of the first screen and the second screen, the one and the plurality of communication apparatuses is displayed in such a manner that an inkjet printer which performs printing in an inkjet method and an electrophotographic printer which performs printing in an electrophotographic method are distinguishable from each other.

17. The control method according to claim 1,
wherein, in the first operation environment, the first OS serving as the host OS is an Android® OS, and the guest OS is not running on the host OS, and
wherein, in the second operation environment, the second OS serving as the host OS is a Chrome® OS, and the guest OS is a virtual Android® OS.

18. The control method according to claim 1, further comprising:
causing the predetermined program to determine whether an environment in which the predetermined program is running is the first operation environment or the second operation environment;
performing control based on the environment in which the predetermined program is running being determined to be the first operation environment, in such a manner that, even if a communication apparatus incompatible with the predetermined program is included in the one or the plurality of communication apparatuses found by the search conducted by the first information processing apparatus, the one or the plurality of communication apparatuses including the communication apparatus incompatible with the predetermined program is displayed on the first screen; and
performing control based on the environment in which the predetermined program is running being determined to be the second operation environment, in such a manner that, even if a communication apparatus incompatible with the predetermined program is included in the one or the plurality of communication apparatuses found by the search conducted by the second information processing apparatus, the one or the plurality of communication apparatuses not including the communication apparatus incompatible with the predetermined program is displayed on the second screen.

19. The control method according to claim 1, wherein the predetermined program is an application program for Android® OS.

20. A non-transitory computer-readable storage medium storing a predetermined program capable of running on an operating system (OS),
wherein the predetermined program causes a computer of a first information processing apparatus including a first operation environment present on a first OS running as a host OS but not present on a guest OS to perform a method comprising:
displaying, on a first screen, one or a plurality of communication apparatuses found by a search conducted based on an instruction issued by the predetermined program running in the first operation environment;
receiving selection of any one communication apparatus from among the one or the plurality of communication apparatuses displayed on the first screen; and
preforming, in a case where the communication apparatus selected from among the one or the plurality of communication apparatuses displayed on the first screen is a communication apparatus incompatible with the predetermined program, processing related to another program different from the predetermined program,
wherein the predetermined program causes a computer of a second information processing apparatus including a second operation environment present on a second OS running as the host OS and present on the guest OS to perform a method comprising:
displaying, on a second screen, one or a plurality of communication apparatuses found by a search conducted based on an instruction issued by the predetermined program running in the second operation environment; and
receiving selection of any one communication apparatus from among the one or the plurality of communication apparatuses displayed on the second screen, and
wherein the predetermined program causes the computer of the first information processing apparatus and the computer of the second information processing apparatus to perform a method comprising:
performing control in such a manner that, even in a case where a communication apparatus incompatible with the predetermined program is included in the one or the plurality of communication apparatuses found by the search conducted by the first information processing apparatus, the one or the plurality of communication apparatuses including the communication apparatus incompatible with the predetermined program is displayed on the first screen; and
performing control in such a manner that, in a case where a communication apparatus incompatible with the predetermined program is included in the one or the plurality of communication apparatuses found by the search conducted by the second information processing apparatus, the one or the plurality of communication apparatuses not including the communication apparatus incompatible with the predetermined program is displayed on the second screen.
